(19) United States
(12) Patent Application Publication
(10) Pub. No.: US 2025/0170481 A1
(43) Pub. Date: May 29, 2025

(54) FRAME SYNCHRONIZATION METHOD, FRAME SYNCHRONIZATION APPARATUS, ELECTRONIC DEVICE, AND COMPUTER STORAGE MEDIUM

(71) Applicant: Tencent Technology (Shenzhen) Company Limited, Shenzhen (CN)

(72) Inventor: Fei XU, Shenzhen (CN)

(21) Appl. No.: 19/040,217

(22) Filed: Jan. 29, 2025

Related U.S. Application Data
(63) Continuation of application No. PCT/CN2023/129077, filed on Nov. 1, 2023.

(30) Foreign Application Priority Data
Feb. 7, 2023 (CN) 202310150832.0

(51) Int. Cl. A63F 13/52; A63F 13/35; G06F 3/14

(52) U.S. Cl. CPC A63F 13/52; A63F 13/35; G06F 3/1454

(57) ABSTRACT

Embodiments of this application provide a frame synchronization method performed by an electronic device. The method includes: receiving a local input operation on a virtual scene in a current logical frame, and transmitting local operation data corresponding to the local input operation to a server; determining running logic of the virtual scene in the current logical frame based on the local operation data; receiving an input data packet periodically delivered by the server, the input data packet including: peer operation data inputted by another client corresponding to the plurality of logical frames; updating the running logic in the current logical frame based on the input data packet, to obtain updated logic of the current logical frame; rendering the virtual scene based on the updated logic, to obtain a frame-synchronized virtual scene video; and playing the frame-synchronized virtual scene video.

### CROSS-REFERENCE TO RELATED APPLICATIONS

This application is a continuation application of PCT Patent Application No. PCT/CN2023/129077, entitled “FRAME SYNCHRONIZATION METHOD, FRAME SYNCHRONIZATION APPARATUS, ELECTRONIC DEVICE, AND COMPUTER STORAGE MEDIUM” filed on Nov. 1, 2023, which claims priority to Chinese Patent Application No. 2023101508320, entitled “FRAME SYNCHRONIZATION METHOD, FRAME SYNCHRONIZATION APPARATUS, ELECTRONIC DEVICE, AND COMPUTER STORAGE MEDIUM” filed on Feb. 7, 2023, both of which are incorporated herein by reference in their entirety.

### FIELD OF THE TECHNOLOGY

Embodiments of this application relate to the field of Internet, and relate to, but are not limited to, a frame synchronization method, a frame synchronization apparatus, an electronic device, and a computer storage medium.

### BACKGROUND OF THE DISCLOSURE

In a network battle game, a scenario in which a plurality of players battle together or two players battle against each other exists. A game operation command triggered by an operation of one of the players needs to be synchronized to a game picture of another player in the same game scene as the player for display. Because a game picture frame synchronization mechanism plays a crucial role in game experience of the players, how to achieve game picture synchronization becomes one of problems urgently to be resolved in this field.

Currently, in a process of game frame synchronization in the related art, input of game running logic in a client is completely controlled by a frame number and a corresponding input delivered by a server. When a message of a subsequent frame is not received, game logic is in a waiting state, and the game picture also stops, resulting in an unsmooth picture. In addition, a frame synchronization method in the related art is affected by a network status. When a network of an opponent is poor, a message of the opponent triggers rollback of a game state, resulting in client lag and greatly improving computing overheads of a game device.

### SUMMARY

Embodiments of this application provide a frame synchronization method, a frame synchronization apparatus, an electronic device, and a computer storage medium, which can be applicable to at least the fields of gaming and animation production. Running logic in a current logical frame can be updated according to operation data of a local terminal and operation data of another client, and a virtual scene is rendered through the updated running logic, so that a picture standstill is not caused in the scene due to network impact on the local terminal and the another client, smoothness of a virtual scene video is improved, and computing overheads of devices such as a local terminal and another client are greatly reduced.

The technical solutions of the embodiments of this application are implemented as follows:

An embodiment of this application provides a frame synchronization method. The method is performed by an electronic device and includes: receiving a local input operation on a virtual scene in a current logical frame, and transmitting local operation data corresponding to the local input operation to a server; determining running logic of the virtual scene in the current logical frame based on the local operation data; receiving an input data packet periodically delivered by the server, the input data packet including: peer operation data inputted by another client corresponding to the plurality of logical frames; updating the running logic in the current logical frame based on the input data packet, to obtain updated logic of the virtual scene in the current logical frame; rendering the virtual scene based on the updated logic, to obtain a frame-synchronized virtual scene video; and playing the frame-synchronized virtual scene video.

An embodiment of this application provides an electronic device, including: a memory, configured to store executable instructions; and a processor, configured to implement, when executing the executable instructions stored in the memory, the foregoing frame synchronization method.

An embodiment of this application provides a non-transitory computer-readable storage medium, having executable instructions stored therein, when the executable instructions being executed by a processor, the foregoing frame synchronization method being implemented.

The embodiments of this application have the following beneficial effects: First, a terminal predicts running logic of a virtual scene in a current logical frame based on an input operation of a current terminal in the current logical frame, to avoid a phenomenon that the virtual scene is stalled due to logic waiting. Then, currently, the terminal transmits operation data of a local terminal to a server, and the server delivers an input data packet according to the operation data of the local terminal and operation data of another client, and updates running logic predicted by the local terminal according to the data packet delivered by the server. In the embodiments of this application, the running logic is updated by using the data packet corresponding to the operation data delivered by the server, so that accuracy of the running logic of the virtual scene can be improved on the basis of ensuring logic coherence, thereby improving accuracy of a virtual scene video, and avoiding an invalid operation inputted by a user due to an incorrect picture. Finally, in this application, when the virtual scene is rendered by using the updated running logic, a final virtual scene video can be obtained by rendering only once, so that rendering data and time are reduced, and rendering efficiency is improved. The frame synchronization method provided in the embodiments of this application can not only improve smoothness of the virtual scene video, but also greatly reduce computing overheads of devices such as a local terminal and another client.

### BRIEF DESCRIPTION OF THE DRAWINGS

FIG. 1A is a schematic diagram of a logic implementation of a local client based on an inter-frame non-waiting frame synchronization manner in the related art.

FIG. 1B is a schematic diagram of another logic implementation of a local client based on an inter-frame non-waiting frame synchronization manner in the related art.

FIG. 1C is a schematic flowchart of a rollback frame synchronization algorithm in the related art.

FIG. 2A is a schematic diagram of an architecture of a frame synchronization system according to an embodiment of this application.

FIG. 2B is a schematic diagram of a structure of an electronic device according to an embodiment of this application.

FIG. 3 is a schematic flowchart of a frame synchronization method according to an embodiment of this application.

FIG. 4 is another schematic flowchart of a frame synchronization method according to an embodiment of this application.

FIG. 5 is a schematic flowchart of an implementation of determining running logic of a virtual scene in a current logical frame according to an embodiment of this application.

FIG. 6 is a schematic diagram of a comparison of character states of two adjacent frames after running logic is predicted according to an embodiment of this application.

FIG. 7 is a schematic flowchart of an implementation of updating running logic in a current logical frame according to an embodiment of this application.

FIG. 8 is a schematic diagram of a server receiving operation data of different clients according to an embodiment of this application.

FIG. 9 is a schematic diagram of a server delivering input data packets to different clients according to an embodiment of this application.

FIG. 10 is a schematic diagram of a frame synchronization method according to an embodiment of this application.

FIG. 11 is a schematic flowchart of logic updating of a frame in a client game according to an embodiment of this application.

FIG. 12 is a schematic flowchart of a frame synchronization method in three cases according to an embodiment of this application.

FIG. 13 is a schematic flowchart of a frame synchronization method in a case of N being less than M according to an embodiment of this application.

### DESCRIPTION OF EMBODIMENTS

To make the objectives, technical solutions, and advantages of this application clearer, the following further describes this application in detail with reference to the accompanying drawings. The described embodiments are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict. Unless otherwise defined, meanings of all technical and scientific terms used in the embodiments of this application are the same as those usually understood by a person skilled in the art to which the embodiments of this application belongs. Terms used in the embodiments of this application are merely intended to describe objectives of the embodiments of this application, but are not intended to limit this application.

Before the embodiments of this application are described, some professional terms in the embodiments of this application are first described.
(1) Running logic: It refers to rules and operations followed by a system, program, or device when a task is executed. It describes an execution sequence, a condition, and a result of the task, and behaviors and reactions of the system. The running logic is usually developed at a system design and development stage, which can ensure stability, reliability, and correctness of the system, and help developers perform testing and troubleshooting.
(2) 1v1 fighting game: A real-time battle arena game of 1v1 has strong game performance, gorgeous combos, and high operation difficulty. Network battles have a high requirement for real-time performance and hand feeling.
(3) Logical frame: It refers to a time unit for processing game running logic (hereinafter referred to as game logic) in a game engine. In a game, a plurality of logical frames are processed per second. A number of maximum logical frames processed per second is usually fixed, and a common value is 30 frames or 60 frames. A function of the logical frame is to ensure that a logical running speed of the game matches a frame rate, so that stability and smoothness of the game are maintained. Each logical frame is configured for processing some game logic, for example, calculating a position of a character, detecting a collision, and updating a game state. Different game engines may process the logical frame in different manners, but are usually scheduled and processed according to a specific rule. A frame is a snapshot of the game state, a state is updated and a logical frame number is increased according to a fixed time interval. For example, if a number of frames per second (FPS) of the logical frame is 60, it represents 60 frames per second, and an interval of each frame is 16.67 milliseconds (ms).
(4) Frame synchronization: In a game network synchronization manner, game logic is completely run on a client, inputs of all players need to be synchronized, and each client processes the same input to obtain a consistent result.
(5) Inter-frame non-waiting frame synchronization: The server controls the increase of a game logical frame. The server receives inputs uploaded by players, and regularly broadcasts the inputs to all clients. A single client does not need to wait for another client, but only needs to wait for the server to deliver data.
(6) Rollback frame synchronization: A logical frame is increased locally, an opponent input delivered by the server is not waited for locally, the opponent input is predicted, and is transmitted to the game logic in combination with a local input of the local end. When an opponent input message of a past frame is received, the game state is rollbacked, and the game logic is fast-forwarded to a current data frame according to a latest input.
(7) Input delay: Generally, when the client presses a key, a key input is immediately used as game logic in the current data frame. For a network battle game, an input delay, also referred to as an input cache, may be set. For example, an input delay of 3 frames means that when an input is pressed, the input is added to an end of a queue with a size of 3, a first queue element is popped up in each frame of the queue to the game logic, and the input just pressed is transmitted to the game logic only after actual three frames, and is sent to the server. If an input packet of the server is sent back within the delay of 3 frames, no additional processing is generated, otherwise there is additional processing (rollback or waiting) locally. To enable the experience of the network battle to be the same as that of a stand-alone mode, a fixed input delay is generally set in the stand-alone mode of the fighting game, and some games are even opened to the player to set this value.

A frame synchronization technology in the related art is described below.

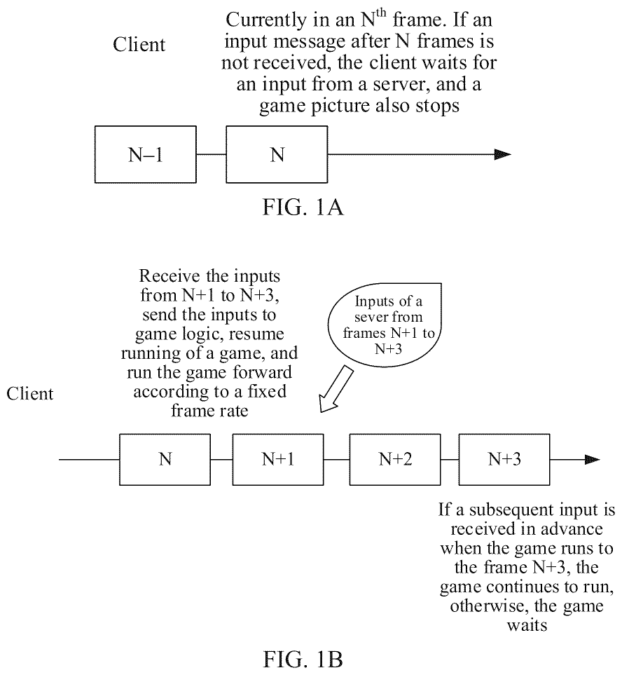

In the related art, consecutiveness of the virtual scene may be implemented based on an inter-frame non-waiting frame synchronization manner. In this manner, the increase of the frame number is controlled by the server, and when a client player presses a key, the input is immediately sent to the server. However, a game logic input of the client is completely controlled by a frame number delivered by the server and a corresponding input. If no message of a subsequent frame is received, the logic waits, and a picture also stops. FIG. 1A is a schematic diagram of a logic implementation of a local client based on inter-frame non-waiting frame synchronization in the related art. As shown in FIG. 1A, a local client is currently in an N^{th} frame. If an input message after N frames is not received, the client waits for an input from the server, and the game picture also stops. In which frame the server receives the message of the player, a player input is filled in a structure of which frame, and does not wait for all player inputs in this frame to be received. Therefore, a player with fast network may be received by the server first, and a player with slow network may be received later, to fill a subsequent frame. However, when a local network fluctuates greatly, subsequent frames of messages inputted by the server (for example, an (N+1)^{th} frame to an (N+3)^{th} frame) may arrive later than expected (a stable interval between the N^{th} frame, where 48 milliseconds for frame N being equal to 3), and the client has run locally to the N^{th} frame. In this case, the logic waits, the picture also stalls, and the experience is affected. The frequent fluctuation is like the experience of slides, as shown in FIG. 1B. FIG. 1B is a schematic diagram of another logic implementation of a local client based on an inter-frame non-waiting frame synchronization manner in the related art.

In the related art, consecutiveness of the virtual scene may also be implemented based on a rollback frame synchronization manner. In this manner, the logical frame is completely increased locally by the client, and the input is also increased locally by the client. A local input is directly transmitted to the game logic, and an input of an opponent client is predicted, which is the same as a stand-alone game. In addition, an input at the local end is sent to an opponent through a network.

When the local end receives an opponent message sent by the network, if the opponent message is an input of a past frame N, a recorded opponent input predicted in an N^{th} frame is compared. If the input of the past frame N is the same as the opponent input predicted in the N^{th} frame, no processing is performed; and if the input of the past frame N is different from the opponent input predicted in the N^{th} frame, an input from the N^{th} frame to the current data frame is updated, the game state is rollbacked to the N^{th} frame as a whole, and then the game logic is fast-forwarded to the current data frame by using a new input. In this case, the game state has been corrected according to the new input, and then the game continues to be run forward. Because several frames are rollbacked for correction and fast-forwarded, a picture may be lost in several frames. For example, it may be seen in the picture that an opponent suddenly throws a punch without raising the hand, or suddenly transients forward by several frames. This phenomenon is referred to as a visual glitch.

A rollback frame synchronization algorithm is intended to resolve conventional frame synchronization, and a problem that time from triggering to application to game logic of the input at the local end is affected by a network delay. Because the input of the algorithm at the local end is applied to the game logic at a fixed interval, stability of an input feedback is ensured, that is, the so-called “hand feeling”. The interval may be 0, or may be a fixed number of frames (for example, a stand-alone fighting game is 4 frames). The fighting game is a high-difficulty game that determines a frame accuracy. The player pays special attention to the hand feeling, so that the algorithm ensures the hand feeling as a priority, sacrificing consecutiveness of a bit of picture. In a rollback frame synchronization technology, because an opponent message triggers rollback, if a frame number of the received opponent message is older, a degree of the rollback is greater. Therefore, a poor network for the opponent affects the user experience of the local end. The opponent message arrives at the local terminal early or late is affected by many factors, for example, stalling of the network and the client. As shown in FIG. 1C, FIG. 1C is a schematic flowchart of a rollback frame synchronization algorithm in the related art, and shows a procedure of the rollback frame synchronization algorithm.

Based on at least one problem existing in the related art, an embodiment of this application provides a frame synchronization method, so that a network of the opponent does not affect picture performance of the player, and picture stalling is not caused by a network stall of the opponent, but only loss of some picture frames, thereby improving overall game smoothness.

According to the frame synchronization method provided in the embodiments of this application, first, running logic of a virtual scene in a current logical frame is predicted based on an input operation of a current terminal in the current logical frame, so that running logic of a local virtual scene is coherent, and a scene stall does not occur due to logic waiting. Then, currently, the terminal transmits the operation data of the local end to the server, and the server delivers an input data packet according to the operation data of the local end and the operation data of another client, and updates the running logic predicted by the local end according to the data packet delivered by the server. In the embodiments of this application, the running logic is updated by using the data packet corresponding to the operation data, so that accuracy of the running logic of the virtual scene can be improved on the basis of ensuring logic coherence, thereby improving accuracy of a virtual scene video, and avoiding an invalid operation inputted by user due to an incorrect picture. Finally, in this application, when the virtual scene is rendered by using the updated running logic, a final virtual scene video can be obtained by rendering only once, so that rendering data and time are reduced, and rendering efficiency is improved. The frame synchronization method provided in the embodiments of this application can not only improve smoothness of the virtual scene video, but also greatly reduce computing overheads of devices such as a local terminal and another client.

An exemplary application of a frame synchronization device in the embodiments of this application is first described herein. The frame synchronization device may be implemented as a terminal, and the terminal is an electronic device configured to implement the frame synchronization method. In an implementation, the frame synchronization device provided in the embodiments of this application may be implemented as any terminal capable of running a game application or having an animation generation function, such as a notebook computer, a tablet computer, a desktop computer, a mobile phone, a portable music player, a personal digital assistant, a dedicated message device, a portable game device, a smart robot, a smart home appliance, or a smart in-vehicle device. An exemplary application in which the frame synchronization device is implemented as a terminal is described below.

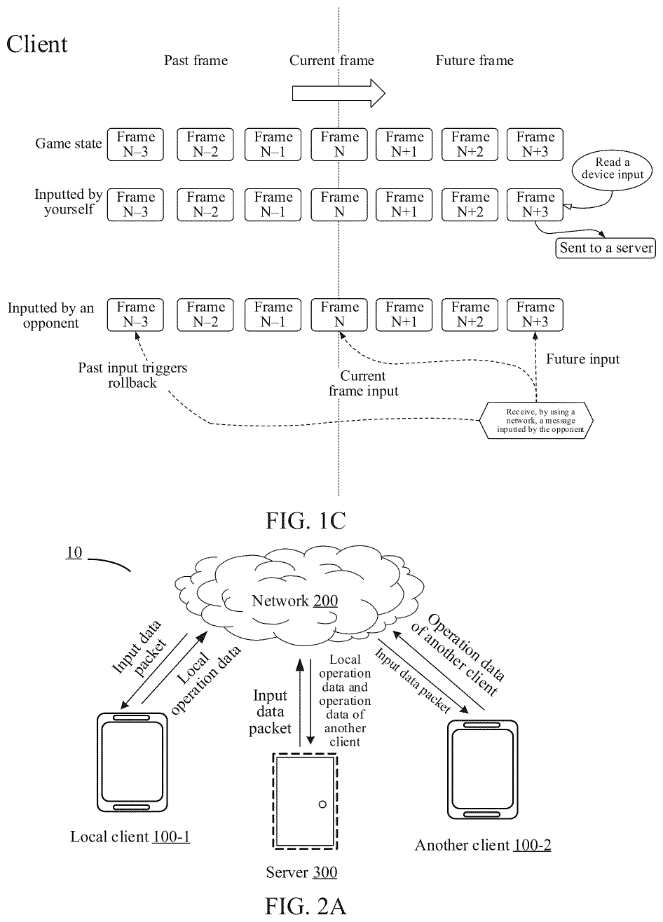

FIG. 2A is a schematic diagram of an architecture of a frame synchronization system according to an embodiment of this application. In the embodiments of this application, an example in which the frame synchronization method is applied to a two-player battle game application is used for description. When the two-player battle game runs, the two-player battle game correspondingly includes a local end and a peer end. The local end is a terminal held by a player A, the peer end is a terminal held by an opponent B, and the local end and the peer end are two opposite ends. After the player A and the opponent B exchange identities, the peer end becomes a local end of the player B (that is, the opponent B). The two-player battle game application is run on both the local end and the peer end. Clients (which are respectively a local client and another client) of the two-player battle game application are arranged on the local end and the peer end. Operation data of the local client and the another client is sent to the server by using the network. The server processes and delivers a data packet to the local client and the another client. In the embodiments of this application, the frame synchronization system includes at least a local client 100-1, another client 100-2, a network 200, and a server 300. The local client 100-1 may form the frame synchronization device in the embodiments of this application. The local client 100-1 and the another client 100-2 are connected to the server 300 by using the network 200, and the network 200 may be a wide area network or a local area network, or a combination thereof.

In the embodiments of this application, during frame synchronization, the local client 100-1 receives an input operation on a virtual scene running on the local client 100-1 in a current logical frame, and transmits local operation data corresponding to the input operation to the server 300 by using the network 200. The another client 100-2 receives an input operation on a virtual scene running on the another client 100-2 in the current logical frame, and transmits operation data of the another client corresponding to the input operation to the server 300 by using the network 200. The local client 100-1 determines running logic in the current logical frame of the virtual scene on the local client 100-1 based on the local operation data, and the another client 100-2 determines running logic in the current logical frame of the virtual scene on the another client 100-2 based on the operation data of the another client.

The server 300 determines, according to the local operation data and the a operation data of the another client, local operation data corresponding to a plurality of logical frames on the local client 100-1 and peer operation data inputted by the another client corresponding to the plurality of logical frames on the another client 100-2, further forms the input data packet based on the local operation data and the operation data of the another client, and transmits the input data packet to the local client 100-1 and the another client 100-2 by using the network 200. The local client 100-1 and the another client 100-2 respectively update the running logic of the current logical frame based on the input data packet, to obtain updated logic of the virtual scene in the current logical frame, and respectively render the virtual scene based on the updated logic, to obtain a frame-synchronized virtual scene video, and the virtual scene video is respectively displayed on display interfaces of the local client 100-1 and the another client 100-2.

The frame synchronization method provided in the embodiments of this application may alternatively be implemented based on a cloud platform and through a cloud technology. For example, the foregoing server 300 may be a cloud server. The cloud server periodically delivers the input data packet, and the terminal updates running logic predicted locally according to the data packet delivered by the cloud server.

In some embodiments, there may also be a cloud memory, and the local operation data and the peer operation data may be stored in the cloud memory. In this way, when frame synchronization needs to be performed, the stored local operation data and peer operation data may be obtained from the cloud memory.

The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system requires a large amount of computing and storage resources, such as a video website, an image website, and more portal websites. With the high development and application of the Internet industry, each item may have its own identifier in the future and needs to be transmitted to a background system for logical processing. Data at different levels is separately processed, and data in various industries requires strong system support and this can only be implemented through cloud computing.

The frame synchronization method provided in the embodiments of this application may be implemented by a terminal device and the server in collaboration. A solution implemented by the terminal device and the server in collaboration mainly involves two gaming modes, namely, a local gaming mode and a cloud gaming mode. The local gaming mode refers to that the terminal device and the server cooperatively run game processing logic. A part of operation instructions inputted by a player in the terminal device is processed by the terminal device running the game logic, and another part is processed by the server running the game logic. In addition, the game logic processed by the server is often more complex and requires more computing power. The cloud gaming mode refers to that the server independently runs game logic processing, and the cloud server renders game scene data into audio and video streams, and transmits the audio and video streams to the terminal device by using a network for display. The terminal device only needs to have a basic streaming media playback capability and a capability to obtain operation instructions of the player and send the operation instructions of the player to the server.

FIG. 2B is a schematic diagram of a structure of an electronic device according to an embodiment of this application. The electronic device 301 shown in FIG. 2B may be a frame synchronization device, and the frame synchronization device includes: at least one processor 310, a memory 350, at least one network interface 320, and a user interface 330. Components in the frame synchronization device are coupled together by using a bus system 340. The bus system 340 is configured to implement connection and communication between the components. In addition to a data bus, the bus system 340 further includes a power bus, a control bus, and a state signal bus. However, for clear description, various types of buses in FIG. 2B are marked as the bus system 340.

The processor 310 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The user interface 330 includes one or more output apparatuses 331 that can display media content, and one or more input apparatuses 332.

The memory 350 may be a removable memory, a non-removable memory, or a combination thereof. Exemplary hardware devices include a solid-state memory, a hard disk drive, an optical disc driver, and the like. In some embodiments, the memory 350 includes one or more storage devices away from the processor 310 in a physical position. The memory 350 includes a volatile memory or a non-volatile memory, or may include both a volatile memory and a non-volatile memory. The non-volatile memory may be a read only memory (ROM). The volatile memory may be a random access memory (RAM). The memory 350 described in the embodiments of this application is to include any other suitable type of memories. In some embodiments, the memory 350 may store data to support various operations. Examples of the data include a program, a module, and a data structure, or a subset or a superset thereof, which are described below by using examples.

An operating system 351 includes a system program configured to process various basic system services and perform a hardware-related task, such as a framework layer, a core library layer, or a driver layer, and is configured to implement various basic services and process a hardware-based task. A network communication module 352 is configured to reach another computing device through one or more (wired or wireless) network interfaces 320. Exemplary network interfaces 320 include: Bluetooth, wireless fidelity (WiFi), universal serial bus (USB), and the like. An input processing module 353 is configured to detect one or more user inputs or interactions from one of the one or more input apparatuses 332 and translate the detected input or interaction.

In some embodiments, the apparatus provided in the embodiments of this application may be implemented by using software. FIG. 2B shows a frame synchronization apparatus 354 stored in the memory 350, and the frame synchronization apparatus 354 may be the frame synchronization apparatus in the electronic device 301, which may be software in the form of a program and a plug-in, including the following software modules: a first receiving module 3541, a determining module 3542, a second receiving module 3543, an update module 3544, and a rendering module 3545. These modules are logical modules, and therefore may be randomly combined or further split according to the implemented functions. Functions of the modules are described below.

In some other embodiments, the apparatus provided in the embodiments of this application may be implemented by using hardware. For example, the apparatus provided in the embodiments of this application may be a processor in a form of a hardware decoding processor, programmed to perform the frame synchronization method provided in the embodiments of this application. For example, the processor in the form of a hardware decoding processor may use one or more application specific integrated circuits (ASICs), a DSP, a programmable logic device (PLD), a complex programmable logic device (CPLD), a field-programmable gate array (FPGA), or other electronic components.

The frame synchronization method provided in the embodiments of this application may be performed by an electronic device. The electronic device may be a terminal. In other words, the frame synchronization method in the embodiments of this application may be performed by a terminal, or may be performed through interaction between a server and a terminal.

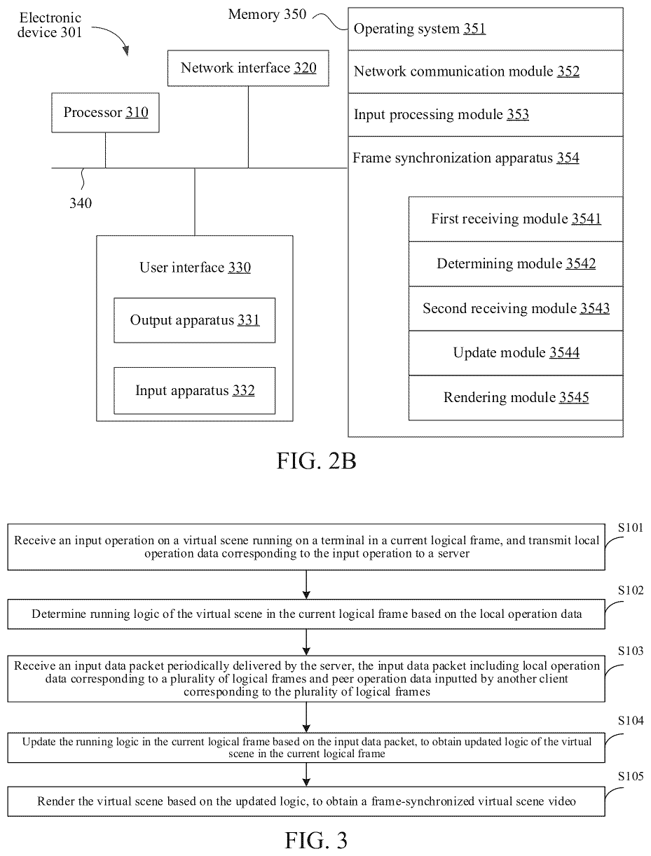

FIG. 3 is a schematic flowchart of a frame synchronization method according to an embodiment of this application. The method is described below with reference to operations shown in FIG. 3. The frame synchronization method in FIG. 3 is described by using an example in which the terminal is used as an execution body. As shown in FIG. 3, the method includes the following operation S101 to operation S105:
Operation S101: Receive an input operation on a virtual scene running on a terminal in a current logical frame, and transmit local operation data corresponding to the input operation to a server.

The frame synchronization method provided in the embodiments of this application may be applicable to a two-player battle game or a multi-player battle game that supports multi-player online for data interaction, for example, a matching game, a ranking game, or a battle game. The virtual scene may be a battle game. The battle game includes at least a local game character controlled through an input operation of a local terminal and another client game character controlled through an input operation of another client terminal. A display interface of the battle game may be displayed on any suitable electronic device having an interface display function. The electronic device may be the same as or different from a device that performs the frame synchronization method. This is not limited herein. For example, the electronic device performing the frame synchronization method may be a notebook computer, an electronic device displaying a first interface may also be the notebook computer, and the first interface may be a display interface of a client running on the notebook computer, or may be a web page displayed in a browser running on the notebook computer.

In some embodiments, the input operation may be an instruction inputted or selected by a user in a current display interface by using an input component or the frame synchronization device. For example, the input operation may be an operation such as displacement or damage to a local game character inputted by the user based on the input component of the terminal. The input component or device may include, but is not limited to, a keyboard, a mouse, a touch screen, a touch pad, or an audio input.

In some embodiments, the logical frame is configured for representing logic of a game. For example, consecutive logical frames are configured for representing a state change of a game character (for example, displacement of the game character or generated damage). The current logical frame may be logic for a battle scenario in a current picture of the game, for example, a logical frame configured for representing that the game character is raising a hand. The input operation of the current logical frame may be an input operation of the user in a current virtual scene. For example, the input operation of the current logical frame may be clicking a key to enable a character to pick up a prop.

In the embodiments of this application, after the input operation of a local end in the current logical frame is obtained, the local operation data is sent to the server through the network.

Because the embodiments of this application may be applied to the battle game, each terminal participating in the battle game receives an input operation on the virtual scene running on the terminal in the current logical frame, and transmits local operation data corresponding to the input operation corresponding to the terminal to the server.
Operation S102: Determine running logic of the virtual scene in the current logical frame based on the local operation data.

In the embodiments of this application, the running logic is the game logic. The local terminal may determine, based on the local operation data of the local end, data such as a state change and health information of the local game character in the current logical frame of the virtual scene, that is, running logic of the local game character. For example, the running logic of the local game character in the current logical frame is raising a hand.

For running logic of the another client game character corresponding to the another client in the current logical frame, prediction logic of the another client game character in the current logical frame may be predicted through historical running logic of the another client game character before the current logical frame, to obtain predicted operation data of the another client in the current logical frame. An operation of the another client in the current logical frame may be implemented by using any feasible logical prediction algorithm, or an operation of a previous logical frame may be repeated.

The running of the another client game character in the current logical frame is obtained according to the local operation data and a prediction operation of the game character corresponding to the another client in the current logical frame. The client may obtain the game state data in the current logical frame by executing the local operation data and the operation data of the another client in the current logical frame.
Operation S103: Receive an input data packet periodically delivered by the server, the input data packet including: local operation data corresponding to a plurality of logical frames and peer operation data inputted by another client corresponding to the plurality of logical frames.

In some embodiments, after receiving operation data of a plurality of clients, the server may package and broadcast, at a fixed interval (for example, every N frames), input data packets corresponding to previous N frames (that is, local operation data corresponding to the previous N frames and the peer operation data inputted by the another client corresponding to the previous N frames) to the local client and the another client, and each client corrects and updates, according to the input data packets, data predicted by the client.

In some embodiments, the input data packet is of an integer data type, and integer data is numerical data that does not include a decimal part, and is represented by a letter I. The integer data is only configured for representing an integer, and is stored in a binary form, for example, 16-bit unsigned integer (uint16), where one uint16 may represent an input of one player, and a frame number generation manner. The input data packet includes at least a frame number of each logical frame, the local operation data and the peer operation data corresponding to each frame number. The frame number is generated by the server through a global timer of the virtual scene. The global timer is a count-up counter with an automatic increment function, and can generate the frame number in a sequentially increasing manner. In the virtual scene, frame numbers of the plurality of consecutive logical frames sequentially increase, and a time interval between two adjacent logical frames is the same. For example, each game of the battle game starts increasing a frame number from 0, and each frame increases at an interval of 16 ms.

In the embodiments of this application, the input data packet in the integer data type is used, so that computing complexity can be reduced, computing resources required for frame synchronization can be increased, and efficiency of frame synchronization can be improved. The input data packet delivered by the server is periodically received, and then the game logic is periodically updated, to ensure logic coherence and improve smoothness of the virtual scene video.
Operation S104: Update the running logic in the current logical frame based on the input data packet, to obtain updated logic of the virtual scene in the current logical frame.

In the embodiments of this application, the local terminal stores a game state of a preset number of frames (for example, 600 frames) and inputs. The game state includes at least all field sets of a local game that can determine a game state, such as a current round, remaining time of the game, a game stage (opening, battling, ending, or the like), a blood volume of each game character, a position, a current trick, a moving state (standing and jumping), whether the game character is in a coma, and whether the game character is attacked, and also states of some third-party objects such as flight props.

After receiving the input data packet delivered by the server, the terminal compares the input data packet with the operation data predicted by the terminal, to update the running logic in the current logical frame. For example, when an input data packet of an N^{th} frame of the server is received, it is assumed that a current logical frame of the terminal is M. When N is greater than M, the input data packet is a future input. In this case, logic of the terminal falls behind the server. In this case, only the future input needs to be updated, the input data packet may be added to an input list, and rendering is subsequently performed according to the operation data in the input data packet. When N is equal to M, whether the input data packet is the same as the running logic in the current logical frame is compared, and if the input data packet is different from the running logic in the current logical frame, the running logic in the current logical frame is updated according to the input data packet, and rendering is subsequently performed according to the updated logic of the current logical frame. When N is less than M, it indicates that the input data packet delivered by the server is a past frame of the current logical frame of the terminal, the operation data of the N^{th} frame stored by the terminal is checked. If the operation data of the N^{th} frame stored by the terminal is the same as the operation data in the input data packet, no processing is required. If the operation data of the N^{th} frame stored by the terminal is different from the operation data in the input data packet, it is necessary to roll back the game state to the N^{th} frame, and then run the game to an M^{th} frame according to operation data from the N^{th} frame to the M^{th} frame, to obtain the updated logic of the virtual scene in the current logical frame.
Operation S105: Render the virtual scene based on the updated logic, to obtain a frame-synchronized virtual scene video.

In the embodiments of this application, the virtual scene is continuously rendered according to the updated logic, and a rendered virtual scene is played at a preset presentation frame playback speed, to play the frame-synchronized virtual scene video on the display interface. The presentation frame is also referred to as a rendering frame, and the presentation frame refers to a time unit for picture presentation of the virtual scene.

In the embodiments of this application, the logic and the representation are separated, so that a presentation layer is not updated when the logical frame is rollbacked or fast-forwarded. When the virtual scene is rendered by using updated running logic, the presentation layer only needs to be rendered once to obtain a final virtual scene video, thereby reducing rendering data and time, and improving rendering efficiency. The presentation layer may be a state in the game that does not affect a game result, such as an interface, a sound, a special effect, and calculation of a bone animation of a character.

According to the frame synchronization method provided in the embodiments of this application, first, the terminal predicts the running logic of the virtual scene in the current logical frame based on the input operation of the current terminal in the current logical frame, to avoid a phenomenon that the virtual scene is stalled due to logic waiting. Then, the current terminal transmits the operation data of the local end to the server. The server delivers the input data packet according to the operation data of the local end and the operation data of the another client, and updates the running logic predicted by the local end according to the data packet delivered by the server. In the embodiments of this application, the running logic is updated by using the data packet corresponding to the operation data delivered by the server, so that accuracy of the running logic of the virtual scene can be improved on the basis of ensuring logic coherence, thereby improving accuracy of the virtual scene video, and avoiding an invalid operation inputted by the user due to an incorrect picture. Finally, in this application, when the virtual scene is rendered by using the updated running logic, a final virtual scene video can be obtained by rendering only once, so that rendering data and time are reduced, and rendering efficiency is improved.

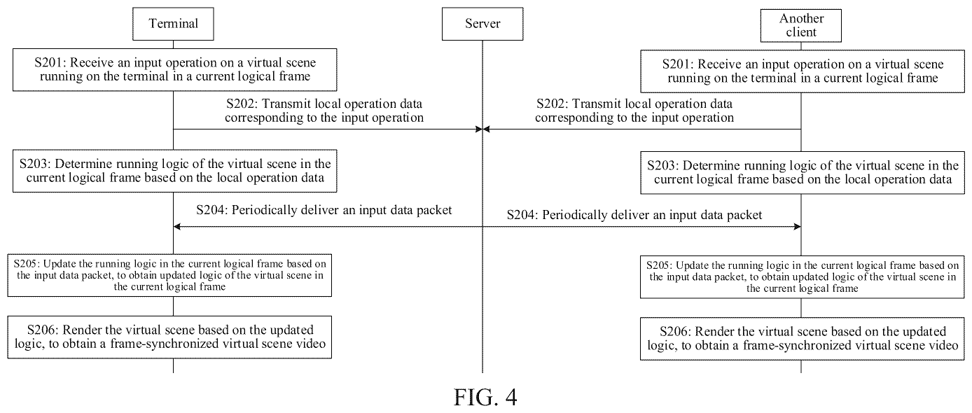

FIG. 4 is another schematic flowchart of a frame synchronization method according to an embodiment of this application. As shown in FIG. 4, the method includes the following operation S201 to operation S210:
Operation S201: A terminal receives an input operation on a virtual scene running on the terminal in a current logical frame.

The terminal corresponds to the local end, and the local end and a peer end run the same round of game with a two-player battle game application. The input operation on the virtual scene running on the terminal in the current logical frame may be received by using a local client of the two-player battle game application running on the terminal.
Operation S202: The terminal transmits local operation data corresponding to the input operation to a server.
Operation S203: The terminal determines running logic of the virtual scene in the current logical frame based on the local operation data.

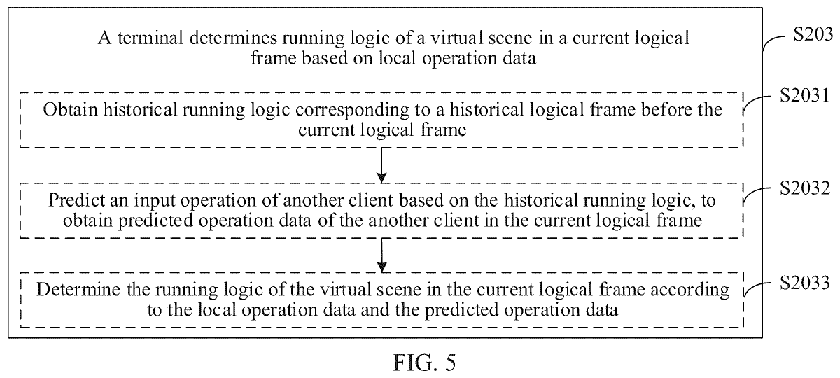

In some embodiments, FIG. 5 is a schematic flowchart of an implementation of determining running logic of a virtual scene in a current logical frame according to an embodiment of this application. FIG. 5 shows that the running logic of the virtual scene in the current logical frame is determined in operation S203, which may be implemented through the following operation S2031 to operation S2033:
Operation S2031: Obtain historical running logic corresponding to a historical logical frame before the current logical frame.
Operation S2032: Predict an input operation of the another client based on the historical running logic, to obtain predicted operation data of the another client in the current logical frame.

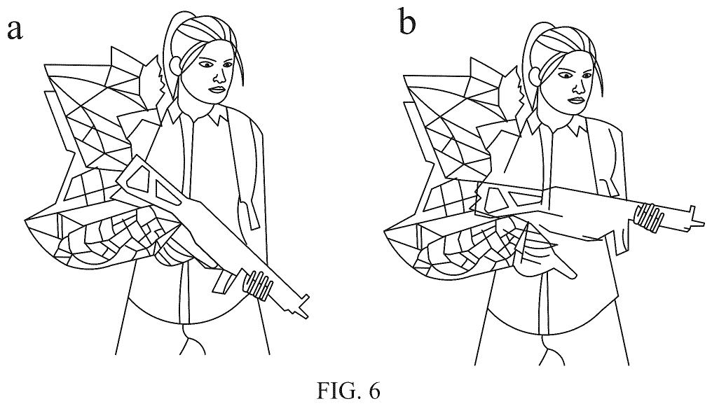

The obtaining historical running logic mainly refers to obtaining historical logic corresponding to a historical logical frame of a game character corresponding to another client, and predicting the input operation of the another client according to the historical logic, to obtain predicted operation data of the another client in the current logical frame, as shown in FIG. 6. FIG. 6 is a schematic diagram of a comparison of character states of two adjacent frames after running logical is predicted according to an embodiment of this application. Part a in FIG. 6 is an image of a historical logical frame. A state corresponding to a game character corresponding to another client is holding a virtual prop, and the virtual prop may be a gun in a game. If it is determined, according to the historical running logic, that the game character corresponding to the another client wants to be attacked, a state corresponding to the game character corresponding to the another client in the current logical frame is predicted to be raising a virtual prop, and then predicted operation data of the another client in the current logical frame is obtained. A state corresponding to the predicted operation data is shown in part b in FIG. 6.

In some embodiments, predicting the running logic of the another client in the current logical frame may alternatively be repeating running logic in a previous logical frame before the current logical frame of the another client, that is, copying the running logic of the previous logical frame to the current logical frame.
Operation S2033: Determine running logic of the virtual scene in the current logical frame according to the local operation data and the predicted operation data.
Operation S204: The server periodically delivers an input data packet. The input data packet includes: local operation data corresponding to a plurality of logical frames and peer operation data inputted by another client corresponding to the plurality of logical frames.

After receiving the local operation data and the operation data of the another client, the server delivers, to a client terminal performing battle, the local operation data and the operation data of the another client through the network. Herein, the server may periodically deliver the input data packet, for example, deliver the local operation data and the peer operation data of a previous N frames to the terminal every N frames.

In some embodiments, the input data packet includes a frame number of each logical frame, the local operation data and the peer operation data corresponding to each frame number. The frame number is generated by the server through a global timer of the virtual scene. In the virtual scene, frame numbers of a plurality of consecutive logical frames sequentially increase, and a time interval between two adjacent logical frames is the same.
Operation S205: The terminal updates the running logic in the current logical frame based on the input data packet, to obtain updated logic of the virtual scene in the current logical frame.

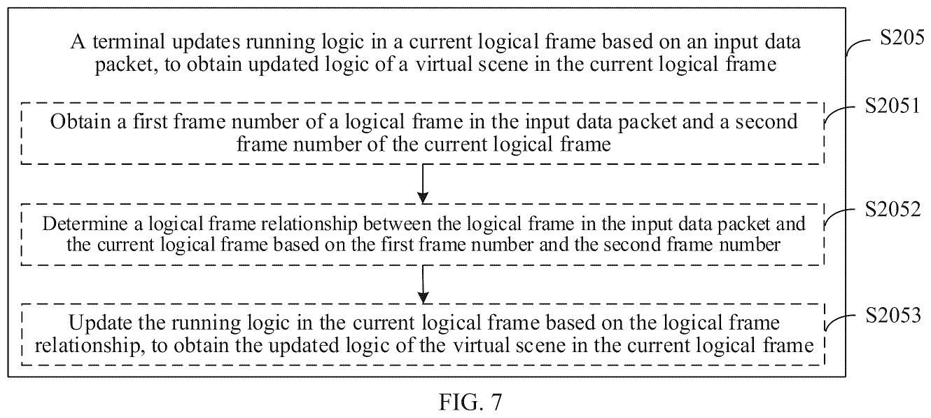

In some embodiments, FIG. 7 is a schematic flowchart of an implementation of updating running logic in a current logical frame according to an embodiment of this application. FIG. 7 shows that the running logic in the current logical frame is updated in operation S205, which may be implemented through the following operation S2051 to operation S2053:
Operation S2051: Obtain a first frame number of a logical frame in the input data packet and a second frame number of the current logical frame.

There may be operation data corresponding to a plurality of frames in the input data packet, and a first frame number N of a logical frame corresponding to each frame of operation data and a second frame number M of a current logical frame corresponding to the terminal are obtained.
Operation S2052: Determine a logical frame relationship between the logical frame in the input data packet and the current logical frame based on the first frame number and the second frame number.

In some embodiments, the logical frame relationship between the logical frame in the input data packet and the current logical frame may be determined according to a numerical relationship between the first frame number and the second frame number. In response to the first frame number being greater than the second frame number, it is determined that the logical frame relationship is that the logical frame is a future frame of the current logical frame. In other words, when N is greater than M, the logical frame in the input data packet is the future frame of the current logical frame. In response to the first frame number being equal to the second frame number, it is determined that the logical frame relationship is that the logical frame is the current logical frame. In other words, when N is equal to M, the logical frame in the input data packet is the current logical frame. In response to the first frame number being less than the second frame number, it is determined that the logical frame relationship is that the logical frame is a past frame of the current logical frame. In other words, when N is less than M, the logical frame in the input data packet is the past frame of the current logical frame.
Operation S2053: Update the running logic in the current logical frame based on the logical frame relationship, to obtain the updated logic of the virtual scene in the current logical frame.

In some embodiments, when the logical frame is the future frame of the current logical frame, operation S2053 is implemented in the following manner:

First, in response to the logical frame relationship being that the logical frame is the future frame of the current logical frame, the local operation data and the peer operation data in the input data packet are added to a preset input list. Then, the running logic in the current logical frame is updated by using the operation data stored in the input list, to obtain the updated logic of the virtual scene in the current logical frame.

In some embodiments, the preset input list may be configured to store an input data packet corresponding to a future logical frame delivered by the server. When a frame number of the future logical frame is the same as a frame number of the current logical frame, when obtaining the input data of the current logical frame, the terminal queries the preset input list whether there is local operation data and peer operation data corresponding to the current logical frame, and updates the operation data predicted by the terminal by using the local operation data and the peer operation data in the input list.

In some embodiments, the running logic in the current logical frame may be updated in the following manner: First, the operation data of the current logical frame is retrieved from the input list in response to receiving the input operation in the current logical frame. Then, in response to retrieving the operation data of the current logical frame from the input list, the running logic in the current logical frame is updated by using the operation data, to obtain the updated logic of the virtual scene in the current logical frame.

In other words, when receiving the input operation of the current logical frame, the terminal retrieves, in the input list, whether there is operation data of the current logical frame delivered by the server. When there is the operation data of the current logical frame delivered by the server in the input list, the running logic in the current logical frame is updated by using the operation data of the current logical frame delivered by the server, to obtain the updated logic of the virtual scene in the current logical frame.

In some embodiments, when the logical frame is the current logical frame, operation S2053 is implemented in the following manner: in response to the logical frame relationship being that the logical frame is the current logical frame, the running logic in the current logical frame is updated by using the local operation data and the peer operation data in the input data packet, to obtain the updated logic of the virtual scene in the current logical frame. In other words, if the operation data in the input data packet delivered by the server corresponds to the current logical frame, the local operation data and the peer operation data in the input data packet are directly used as the running logic in the current logical frame.

In some embodiments, when the logical frame is the past frame of the current logical frame, operation S2053 is implemented in the following manner:

First, in response to the logical frame relationship being that the logical frame is the past frame of the current logical frame, local operation data of the logical frame corresponding to the first frame number is obtained from a preset storage unit. The preset storage unit may be a local storage unit, and is configured to store local operation data and peer operation data predicted by the terminal. When the logical frame corresponding to the operation data in the input data packet is the past frame of the current logical frame, according to the first frame number (N) of the logical frame corresponding to the operation data in the input data packet, local operation data of the logical frame corresponding to the first frame number is obtained from the preset storage unit. Then, updating of the running logic in the current logical frame is prohibited in response to the local operation data of the logical frame corresponding to the first frame number being the same as the operation data in the input data packet. Finally, in response to the local operation data of the logical frame corresponding to the first frame number being different from the operation data in the input data packet, state rollback is performed on the running logic in the current logical frame, to obtain the updated logic of the virtual scene in the current logical frame.

When the operation data corresponding to the locally predicted first frame number is the same as the operation data in the input data packet, the running logic in the current logical frame does not need to be updated. When the operation data corresponding to the locally predicted first frame number is different from the operation data in the input data packet, the running logic needs to be rollbacked, and an earliest frame number that is in the locally predicted logical frame and that is different from that in the input data packet delivered by the server is found. From the frame number to the current logical frame, different operation data in the past frame is updated by using data in the input data packet.

In some embodiments, performing state rollback on the running logic in the current logical frame may refer to: updating running logic of a logical frame of the virtual scene under the first frame number by using the operation data in the input data packet, to obtain an updated logical frame corresponding to the first frame number; and running the virtual scene to a logical frame corresponding to the second frame number according to the updated logical frame, to obtain the updated logic of the virtual scene in the current logical frame. This may refer to updating running logic in a current logical frame from an earliest frame number with different occurrences, and running the virtual scene to a logical frame corresponding to the second frame number, that is, the current logical frame, to obtain the updated logic of the virtual scene in the current logical frame.
Operation S206: The terminal renders the virtual scene based on the updated logic, to obtain a frame-synchronized virtual scene video.

In some embodiments, an offset may occur between a local logical frame and a server logical frame. To minimize rollback caused by an excessive offset, the local logical frame and the server logical frame can be synchronized. According to the frame synchronization method provided in the embodiments of this application, frame number synchronization between the terminal and the server can be periodically performed, to avoid the client exceeding or falling behind the server by too many frames, resulting in problems of a huge calculation amount, long time consumption, and picture stalling.

Frame number synchronization provided in the embodiments of this application may be implemented in the following manner: First, when the input data packet is received, the frame number of the logical frame in the input data packet and the frame number of the current logical frame are obtained, and frame number synchronization processing is performed on the current logical frame based on the frame number of the logical frame and the frame number of the current logical frame, to obtain a frame number-synchronized logical frame. Then, frame number synchronization processing may be periodically performed. Herein, the synchronization processing may be performed when the local logical frame falls behind, and the local logical frame may be fast-forwarded to a normal frame. If the local logical frame is ahead, the server logical frame is paused and waited, to implement synchronization between the local logical frame and the server logical frame.

After the frame number-synchronized logical frame is obtained, operation S206 may further refer to updating, based on the input data packet, running logic in the frame number-synchronized logical frame, to obtain updated logic of the frame number-synchronized logical frame in the virtual scene.

In the embodiments of this application, through frame number synchronization, a frame synchronization error caused by a frame number error is avoided, so that frame synchronization efficiency is improved, computing resources in a frame synchronization process are saved, and smoothness of the virtual scene video is improved.

In some embodiments, the virtual scene video may include a plurality of consecutive presentation frames. The frame synchronization method provided in the embodiments of this application further includes: prohibiting rendering of presentation frames of the virtual scene when running logic in a current logical frame is updated, where a number of times of updating the running logic in the logical frame corresponding to each presentation frame is less than a number-of-times threshold.

According to the frame synchronization method provided in the embodiments of this application, when the running logic in the current logical frame is updated or rollbacked, the representation frame corresponding to the current logical frame is not rendered, that is, logic and representation are separated, and logical running efficiency is optimized. In this way, in the embodiments of this application, only one logical frame is rendered once, to avoid rendering operation data with incorrect prediction, thereby reducing a calculation amount, and saving rendering time.

An exemplary application of this embodiment of this application in an actual application scenario is described below.

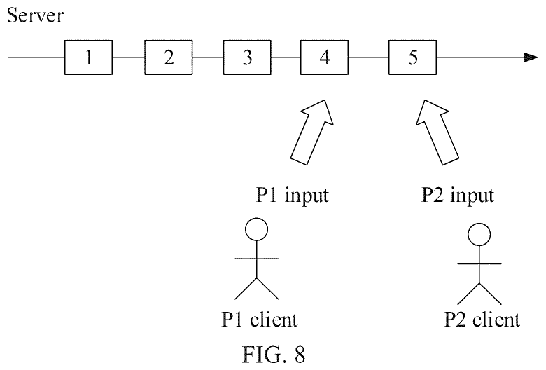

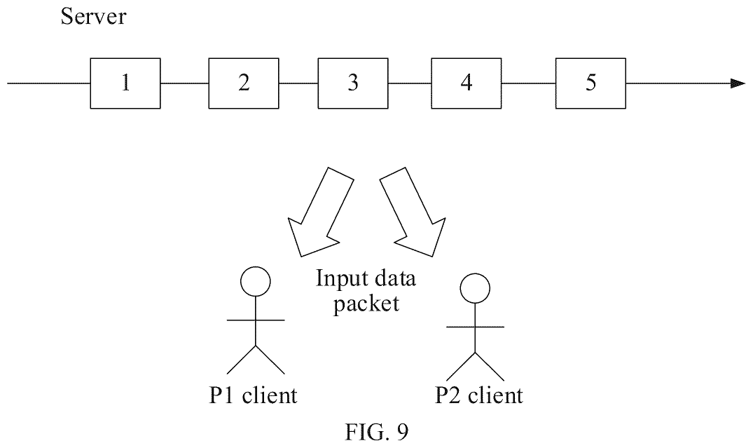

An embodiment of this application provides a frame synchronization method. FIG. 8 is a schematic diagram of a server receiving operation data of different clients according to an embodiment of this application. As shown in FIG. 8, the server receives operation data of different clients (for example, a P1 client and a P2 client), and the server increases a logical frame number at a fixed interval. When an input of a client is received in a frame, the input is filled into an input structure of the frame. For example, when the server receives an input of the P1 client in a 4^{th} frame, the input of the P1 client is filled into the input structure of the 4^{th} frame. Next, FIG. 9 is a schematic diagram of a server delivering input data packets to different clients according to an embodiment of this application. The server may broadcast input packets of the first N frames to all clients every N frames.

Finally, in this application, a logical frame of a client game is still based on data delivered by the server to the client. In the embodiments of this application, when local operation data is sent to the server, the logical frame is run locally according to the local operation data, and running logic in the current logical frame is also obtained. This process is referred to as local prediction. In this case, the game logic no longer waits for the input data packet delivered by the server, so that the current logical frame does not cause logic incoherence and picture stalling due to the failure of the input data packet delivered by the server.

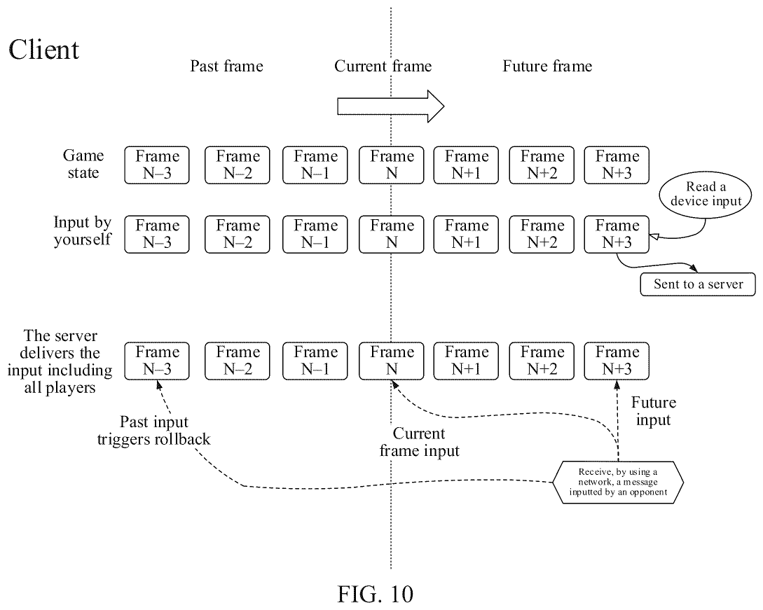

According to the frame synchronization method provided in the embodiments of this application, FIG. 10 is a schematic diagram of a frame synchronization method according to an embodiment of this application. As shown in FIG. 10, an input data packet delivered by a server through a network is input data of all players (including a player corresponding to a local terminal). The input data packet delivered by the server includes a frame number and inputs of all players. Currently, a uint16 represents an input of a player. When the client receives the input data packet (that is, an opponent input message in the figure) sent by the network, if the input data packet is input data of a past frame N−3, opponent input data predicted in an (N−3)^{th} frame recorded by the local terminal is compared. If the predicted opponent input data is the same as the input data delivered by the server, no processing is required. If the predicted opponent input data is different from the input data delivered by the server, inputs from the past frame N−3 to the current data frame N are updated, and an entire game state is rollbacked to the (N−3)^{th} frame. Then, running of the game logic is fast-forwarded to the current data frame N by using the input data packet delivered by the server. In this case, the game state is corrected according to the input data packet delivered by the server, and then the game continues to be run forward.

If the input data packet received by the client from the network is the input data of the current data frame N, the local operation data and the peer operation data in the input data packet are determined as the running logic in the current logical frame N. If the input data packet received by the client from the network is input data of a future frame N+3 of the current data frame, the input data packet may be stored in the preset input list. When the current logical frame N runs to the future frame N+3, data of the input data packet is used as the running logic in the current logical frame.

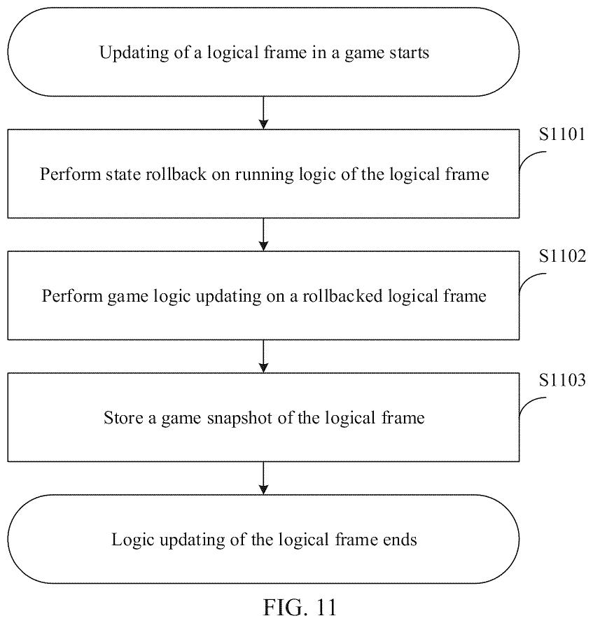

In the embodiments of this application, FIG. 11 is a schematic flowchart of logic updating of a frame in a client game according to an embodiment of this application. The logic updating of a frame in the client game may be implemented in a manner shown in FIG. 11. First, in operation S1101, state rollback is performed on running logic in the logical frame. Then, in operation S1102, game logic updating is performed on the rollbacked logical frame. Then, in operation S1103, a game snapshot of the logical frame is stored, and after the game snapshot of the logical frame is stored, logic updating of the logical frame ends.

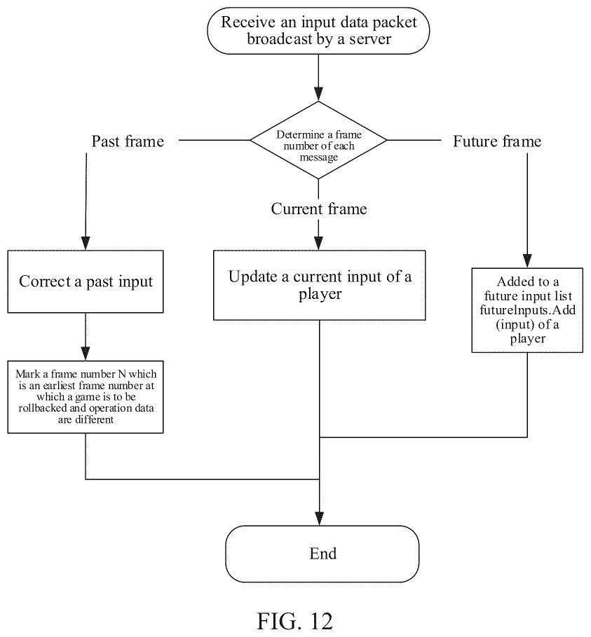

In some embodiments, the local terminal stores a game state and an input for 600 frames (which may be set by itself). When a player input data packet A of an N^{th} frame delivered by the server is received, the input data packet A may be compared with locally stored data. There are three cases. As shown in FIG. 12, FIG. 12 is a schematic flowchart of a frame synchronization method in three cases according to an embodiment of this application.

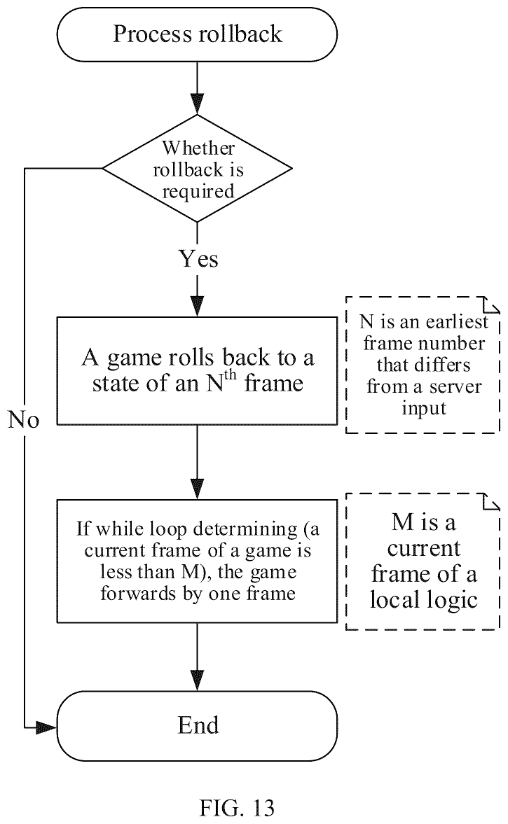

When the terminal receives the input data packet broadcast by the server, determining a frame number of each piece of information may be implemented in the following manner: A frame number N (that is, the first frame number) corresponding to the operation data in the input data packet and a frame number M (that is, the second frame number) of the current logical frame corresponding to the terminal are determined, and a logical frame relationship between the logical frame in the input data packet and the current logical frame is determined according to a numerical relationship between N and M.
Case 1: When N is larger than M, the logical frame relationship is that N is a future frame of M, which indicates that the input data packet broadcast by the server is a future input (that is, a future frame) of the current logical frame, and local logic falls behind server logic. In this case, only the future input needs to be updated. The input data packet A is added to a futureInput list (that is, a future input list of a player). When preparing to obtain the input of the current logical frame, the terminal checks whether futureInput overlaps a frame inputted by the terminal, and when the futureInput overlaps the frame inputted by the terminal, operation data in the input data packet A is determined as the running logic in the current logical frame.
Case 2: When N is equal to M, the logical frame relationship is a current frame, and the operation data of the current logical frame is updated by using the input data packet A.
Case 3: When N is less than M, the logical frame relationship is that N is a past frame of M, which indicates that the input data packet A broadcast by the server is a past input (that is, a past frame) of the current logical frame, operation data B of the N^{th} frame stored by the local terminal is checked, and if the input data packet A delivered by the server is the same as the operation data B stored by the terminal, no processing is required. If A is different from B, it indicates that the peer operation data predicted by the local terminal is incorrect, and a past input needs to be corrected. A frame number which is an earliest frame number at which a game is to be rollbacked and operation data are different is marked, a game state may be rollbacked to an N^{th} frame according to the marked frame number (the N^{th} frame is the earliest frame number with which the operation data differs from the operation data in the input data packet of the server), inputs (that is, the operation data) from frame numbers N to M are updated according to the input data packet A delivered by the server, and then the game is run to the M^{th} frame, where M is a current frame of the local logic, as shown in FIG. 13. FIG. 13 is a schematic flowchart of a frame synchronization method in a case of N being less than M according to an embodiment of this application.

An entire process may be completed through synchronization in one function. Time consumption varies according to a number of frames rollbacked, and then the game continues to run. In some embodiments, it only takes about 100 ms to run the logic of 3000 frames, and in most cases, the rollback is below 5 frames. Therefore, in the embodiments of this application, time consumption of the rollback is low, and picture stalling is avoided.

In some embodiments, an offset may occur between the local logical frame and the server logical frame. To minimize rollback caused by an excessive offset, a synchronization mechanism between the local logical frame and the server logical frame is performed. When the game starts, the local logic performs frame number synchronization once when receiving a first input message packet from the server, and then performs periodic synchronization (for example, 5 seconds), to prevent the client from exceeding or falling behind the server by too many frames, and a difference between frames of the server and the client cannot exceed a number of frames calculated due to a network delay. For example, a network round-trip delay is 128 milliseconds (ms). Theoretically, it needs 128/2/16=4 frames for a new message from the server to arrive locally. Therefore, it is a normal range to receive messages 4 frames ago. If the messages exceed 4 frames, a synchronization mechanism is performed. If the local client falls behind the server, the local client fast-forwards to a normal frame; or if the local client is ahead of the server, the server pauses and waits for the server to arrive at a specified frame.

In the embodiments of this application, separation of logic and presentation of a game is implemented, and logic running efficiency is optimized. Pure logic fast-forwarding 4000 frames only takes about 20 ms, and if there are a few frames, it takes less than 1 ms. The game state snapshot as a whole is defined, stored, and read, and performance is optimized, so that a snapshot of a frame is about 4 kb, and required memory space is reduced. In the embodiments of this application, the presentation layer is not updated when the game is rollbacked and fast-forwarded, and the presentation layer is updated only once in each rendering frame, which separates time-consuming operations of the presentation layer.

In the embodiments of this application, general implementation key points of the frame synchronization method include: deterministic logic, where all space and time units are integers to eliminate differences in platform floating point precision; random number seeds are uniformly delivered to ensure consistency of all clients; a dictionary is replaced with a sorted dictionary or List/Array, to ensure that data storage orders are consistent; and a network transmission layer uses a fast and reliable protocol (for example, a KCP open source library) to implement reliable user datagram protocol (UDP) transmission, to avoid out-of-order and packet loss retransmission of an underlying UDP, and ensure data consistency of message receiving and sending, which is the basis of a frame synchronization solution.

In the embodiments of this application, content of user information, for example, information such as local operation data, and operation data of another client, are involved. If data related to user information or corporate information is involved, when the embodiments of this application are applied to specific products or technologies, permission or consent of the user needs to be obtained, and collection, use, and processing of the relevant data need to comply with relevant laws, regulations, and standards of relevant countries and regions.

The following continuously describes an exemplary structure that a frame synchronization apparatus 354 provided in the embodiments of this application is implemented as software modules. In some embodiments, as shown in FIG. 2B, the frame synchronization apparatus 354 includes:
a first receiving module 3541, configured to receive an input operation on a virtual scene running on a terminal in a current logical frame, and transmit local operation data corresponding to the input operation to a server; a determining module 3542, configured to determine running logic of the virtual scene in the current logical frame based on the local operation data; a second receiving module 3543, configured to receive an input data packet periodically delivered by the server, where the input data packet includes: local operation data corresponding to a plurality of logical frames and peer operation data inputted by another client corresponding to the plurality of logical frames; an update module 3544, configured to update the running logic in the current logical frame based on the input data packet, to obtain updated logic of the virtual scene in the current logical frame; and a rendering module 3545, configured to render the virtual scene based on the updated logic, to obtain a frame-synchronized virtual scene video.

In some embodiments, the determining module is further configured to obtain historical running logic corresponding to a historical logical frame before the current logical frame; predict an input operation of the another client based on the historical running logic, to obtain predicted operation data of the another client in the current logical frame; and determine running logic of the virtual scene in the current logical frame according to the local operation data and the predicted operation data.

In some embodiments, the input data packet may be of an integer data type. Herein, the input data packet includes: a frame number of each logical frame, the local operation data and the peer operation data corresponding to each frame number, where the frame number is generated by the server through a global timer of the virtual scene; and in the virtual scene, frame numbers of a plurality of consecutive logical frames sequentially increase, and a time interval between two adjacent logical frames is the same.

In some embodiments, the update module is further configured to obtain a first frame number of a logical frame in the input data packet and a second frame number of a current logical frame; determine a logical frame relationship between the logical frame in the input data packet and the current logical frame based on the first frame number and the second frame number; and update the running logic in the current logical frame based on the logical frame relationship, to obtain the updated logic of the virtual scene in the current logical frame.

In some embodiments, the update module is further configured to: determine, in response to the first frame number being greater than the second frame number, that the logical frame relationship is that the logical frame is a future frame of the current logical frame; determine, in response to the first frame number being equal to the second frame number, that the logical frame relationship is that the logical frame is the current logical frame; and determine, in response to the first frame number being less than the second frame number, that the logical frame relationship is that the logical frame is a past frame of the current logical frame.

In some embodiments, the update module is further configured to: add, in response to the logical frame relationship being that the logical frame is the future frame of the current logical frame, the local operation data and the peer operation data in the input data packet to a preset input list; and update the running logic in the current logical frame by using the operation data stored in the input list, to obtain the updated logic of the virtual scene in the current logical frame.

In some embodiments, the update module is further configured to retrieve the operation data of the current logical frame from the input list in response to receiving the input operation in the current logical frame; and update, in response to retrieving the operation data of the current logical frame from the input list, the running logic in the current logical frame by using the operation data, to obtain the updated logic of the virtual scene in the current logical frame.

In some embodiments, the update module is further configured to update, in response to the logical frame relationship being that the logical frame is the current logical frame, the running logic in the current logical frame by using the local operation data and the peer operation data in the input data packet, to obtain the updated logic of the virtual scene in the current logical frame.

In some embodiments, the update module is further configured to: obtain, in response to the logical frame relationship being that the logical frame is the past frame of the current logical frame, local operation data of a logical frame corresponding to the first frame number from a preset storage unit; prohibit updating of the running logic in the current logical frame in response to the local operation data of the logical frame corresponding to the first frame number being the same as the operation data in the input data packet; and perform, in response to the local operation data of the logical frame corresponding to the first frame number being different from the operation data in the input data packet, state rollback on the running logic in the current logical frame, to obtain the updated logic of the virtual scene in the current logical frame.

In some embodiments, the update module is further configured to update running logic of the virtual scene in a logical frame under the first frame number by using the operation data in the input data packet, to obtain an updated logical frame corresponding to the first frame number; and run the virtual scene to a logical frame corresponding to the second frame number, to obtain the updated logic of the virtual scene in the current logical frame.

In some embodiments, the apparatus further includes an acquisition module, configured to obtain a frame number of a logical frame in the input data packet and a frame number of the current logical frame when the input data packet is received; a synchronization processing module, configured to perform frame number synchronization processing on the current logical frame based on the frame number of the logical frame and the frame number of the current logical frame, to obtain a frame number-synchronized logical frame; and after the obtaining a frame number-synchronized logical frame, the update module is further configured to update, based on the input data packet, running logic in the frame number-synchronized logical frame, to obtain updated logic of the frame number-synchronized logical frame logical frame in the virtual scene.

In some embodiments, the virtual scene video includes a plurality of consecutive presentation frames; and the apparatus further includes a prohibition module, configured to prohibit rendering of representation frames of the virtual scene when the running logic in the current logical frame is updated, where a number of times of updating the running logic in the logical frame corresponding to each presentation frame is less than a number-of-times threshold.

Descriptions of the apparatus embodiments are similar to the descriptions of the foregoing method embodiments. The apparatus embodiments have beneficial effects similar to those of the method embodiments and thus are not repeatedly described. For technical details undisclosed in the apparatus embodiments of this application, refer to descriptions in the method embodiments of this application for understanding.

An embodiment of this application provides a computer program product, where the computer program product includes executable instructions, and the executable instructions are computer instructions. The executable instructions are stored in a computer-readable storage medium. When a processor of an electronic device reads the executable instructions from the computer-readable storage medium, and executes the executable instructions, the electronic device is caused to perform the foregoing method in the embodiments of this application.

An embodiment of this application provides a storage medium having executable instructions stored therein. When the executable instructions are executed by a processor, the processor is caused to perform the method in the embodiments of this application, for example, the method shown in FIG. 3.

In some embodiments, the storage medium may be a non-transitory computer-readable storage medium, and the computer-readable storage medium may be a memory such as a ferromagnetic random access memory (FRAM), a read only memory (ROM), a programmable read only memory (PROM), an erasable programmable read only memory (EPROM), an electrically erasable programmable read only memory (EEPROM), a flash memory, a magnetic surface memory, an optical disk, or a compact disk-read only memory (CD-ROM); or may be any device including one of or any combination of the foregoing memories.

In some embodiments, the executable instructions may be written in a form of a program, software, a software module, a script, or code and according to a programming language (including a compiled or interpreted language or a declarative or procedural language) in any form, and may be deployed in any form, including an independent program or a module, a component, a subroutine, or another unit suitable for use in a computing environment.

For example, the executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts). For example, the executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A frame synchronization method performed by an electronic device, the method comprising:
receiving a local input operation on a virtual scene in a current logical frame;
transmitting local operation data corresponding to the local input operation to a server;
determining running logic of the virtual scene in the current logical frame based on the local operation data;
receiving an input data packet periodically delivered by the server, the input data packet comprising: peer operation data inputted by another client corresponding to the plurality of logical frames;
updating the running logic in the current logical frame based on the input data packet, to obtain updated logic of the virtual scene in the current logical frame;
rendering the virtual scene based on the updated logic, to obtain a frame-synchronized virtual scene video; and
playing the frame-synchronized virtual scene video.

2. The method according to claim 1, wherein the determining running logic of the virtual scene in the current logical frame based on the local operation data comprises:
obtaining historical running logic corresponding to a historical logical frame before the current logical frame;
predicting an input operation of the another client based on the historical running logic, to obtain predicted operation data of the another client in the current logical frame; and
determining the running logic of the virtual scene in the current logical frame according to the local operation data and the predicted operation data.

3. The method according to claim 1, wherein the input data packet comprises: a frame number of each logical frame and the peer operation data corresponding to the frame number, wherein:
the frame number is generated by the server through a global timer of the virtual scene; and in the virtual scene, frame numbers of a plurality of consecutive logical frames sequentially increase, and a time interval between two adjacent logical frames is the same.

4. The method according to claim 1, wherein the updating the running logic in the current logical frame based on the input data packet, to obtain updated logic of the virtual scene in the current logical frame comprises:
obtaining a first frame number of a logical frame in the input data packet and a second frame number of the current logical frame;
determining a logical frame relationship between the logical frame in the input data packet and the current logical frame based on the first frame number and the second frame number; and
updating the running logic in the current logical frame based on the logical frame relationship, to obtain the updated logic of the virtual scene in the current logical frame.

5. The method according to claim 4, wherein the determining a logical frame relationship between the logical frame in the input data packet and the current logical frame based on the first frame number and the second frame number comprises:
determining, in response to the first frame number being greater than the second frame number, that the logical frame relationship is that the logical frame is a future frame of the current logical frame;
determining, in response to the first frame number being equal to the second frame number, that the logical frame relationship is that the logical frame is the current logical frame; and
determining, in response to the first frame number being less than the second frame number, that the logical frame relationship is that the logical frame is a past frame of the current logical frame.

6. The method according to claim 5, wherein the updating the running logic in the current logical frame based on the logical frame relationship, to obtain the updated logic of the virtual scene in the current logical frame comprises:
updating, in response to the logical frame relationship being that the logical frame is the current logical frame, the running logic in the current logical frame by using the peer operation data in the input data packet, to obtain the updated logic of the virtual scene in the current logical frame.

7. The method according to claim 5, wherein the updating the running logic in the current logical frame based on the logical frame relationship, to obtain the updated logic of the virtual scene in the current logical frame comprises:
obtaining, in response to the logical frame relationship being that the logical frame is the past frame of the current logical frame, local operation data of a logical frame corresponding to the first frame number from a preset storage unit;
prohibiting updating of the running logic in the current logical frame in response to the local operation data of the logical frame corresponding to the first frame number being the same as the operation data in the input data packet; and
performing, in response to the local operation data of the logical frame corresponding to the first frame number being different from the operation data in the input data packet, state rollback on the running logic in the current logical frame, to obtain the updated logic of the virtual scene in the current logical frame.

8. The method according to claim 7, wherein the performing state rollback on the running logic in the current logical frame, to obtain the updated logic of the virtual scene in the current logical frame comprises:
updating running logic in a logical frame of the virtual scene under the first frame number by using the operation data in the input data packet, to obtain an updated logical frame corresponding to the first frame number; and
running the virtual scene to a logical frame corresponding to the second frame number according to the updated logical frame, to obtain the updated logic of the virtual scene in the current logical frame.

9. The method according to claim 1, wherein the method further comprises:
obtaining, when the input data packet is received, a frame number of a logical frame in the input data packet and a frame number of the current logical frame;
performing frame number synchronization processing on the current logical frame based on the frame number of the logical frame and the frame number of the current logical frame, to obtain a frame number-synchronized logical frame; and
after the obtaining a frame number-synchronized logical frame, the updating the running logic in the current logical frame based on the input data packet, to obtain updated logic of the virtual scene in the current logical frame comprises:
updating running logic in the frame number-synchronized logical frame based on the input data packet, to obtain updated logic in the frame number-synchronized logical frame in the virtual scene.

10. The method according to claim 1, wherein the virtual scene video comprises a plurality of consecutive presentation frames; and the method further comprises:
prohibiting rendering of the representation frames of the virtual scene when the running logic in the current logical frame is updated, wherein
a number of times of updating running logic in a logical frame corresponding to each presentation frame is less than a number-of-times threshold.

11. An electronic device, comprising:
a memory, configured to store executable instructions; and a processor, configured to implement, when executing the executable instructions stored in the memory, a frame synchronization method including:
receiving a local input operation on a virtual scene in a current logical frame;
transmitting local operation data corresponding to the local input operation to a server;
determining running logic of the virtual scene in the current logical frame based on the local operation data;
receiving an input data packet periodically delivered by the server, the input data packet comprising: peer operation data inputted by another client corresponding to the plurality of logical frames;
updating the running logic in the current logical frame based on the input data packet, to obtain updated logic of the virtual scene in the current logical frame;
rendering the virtual scene based on the updated logic, to obtain a frame-synchronized virtual scene video; and
playing the frame-synchronized virtual scene video.

12. The electronic device according to claim 11, wherein the determining running logic of the virtual scene in the current logical frame based on the local operation data comprises:
obtaining historical running logic corresponding to a historical logical frame before the current logical frame;
predicting an input operation of the another client based on the historical running logic, to obtain predicted operation data of the another client in the current logical frame; and
determining the running logic of the virtual scene in the current logical frame according to the local operation data and the predicted operation data.

13. The electronic device according to claim 11, wherein the input data packet comprises a frame number of each logical frame and the peer operation data corresponding to the frame number, wherein:
the frame number is generated by the server through a global timer of the virtual scene; and in the virtual scene, frame numbers of a plurality of consecutive logical frames sequentially increase, and a time interval between two adjacent logical frames is the same.

14. The electronic device according to claim 11, wherein the updating the running logic in the current logical frame based on the input data packet, to obtain updated logic of the virtual scene in the current logical frame comprises:
obtaining a first frame number of a logical frame in the input data packet and a second frame number of the current logical frame;
determining a logical frame relationship between the logical frame in the input data packet and the current logical frame based on the first frame number and the second frame number; and
updating the running logic in the current logical frame based on the logical frame relationship, to obtain the updated logic of the virtual scene in the current logical frame.

15. The electronic device according to claim 11, wherein the method further comprises:
obtaining, when the input data packet is received, a frame number of a logical frame in the input data packet and a frame number of the current logical frame;
performing frame number synchronization processing on the current logical frame based on the frame number of the logical frame and the frame number of the current logical frame, to obtain a frame number-synchronized logical frame; and
after the obtaining a frame number-synchronized logical frame, the updating the running logic in the current logical frame based on the input data packet, to obtain updated logic of the virtual scene in the current logical frame comprises:
updating running logic in the frame number-synchronized logical frame based on the input data packet, to obtain updated logic in the frame number-synchronized logical frame in the virtual scene.

16. The electronic device according to claim 11, wherein the virtual scene video comprises a plurality of consecutive presentation frames; and the method further comprises:
prohibiting rendering of the representation frames of the virtual scene when the running logic in the current logical frame is updated, wherein
a number of times of updating running logic in a logical frame corresponding to each presentation frame is less than a number-of-times threshold.

17. A non-transitory computer-readable storage medium, having executable instructions stored therein, wherein the executable instructions, when executed by a processor of an electronic device, cause the electronic device to perform a frame synchronization method including:
receiving a local input operation on a virtual scene in a current logical frame;
transmitting local operation data corresponding to the local input operation to a server;
determining running logic of the virtual scene in the current logical frame based on the local operation data;
receiving an input data packet periodically delivered by the server, the input data packet comprising: peer operation data inputted by another client corresponding to the plurality of logical frames;
updating the running logic in the current logical frame based on the input data packet, to obtain updated logic of the virtual scene in the current logical frame;
rendering the virtual scene based on the updated logic, to obtain a frame-synchronized virtual scene video; and
playing the frame-synchronized virtual scene video.

18. The non-transitory computer-readable storage medium according to claim 17, wherein the determining running logic of the virtual scene in the current logical frame based on the local operation data comprises:
obtaining historical running logic corresponding to a historical logical frame before the current logical frame;
predicting an input operation of the another client based on the historical running logic, to obtain predicted operation data of the another client in the current logical frame; and
determining the running logic of the virtual scene in the current logical frame according to the local operation data and the predicted operation data.

19. The non-transitory computer-readable storage medium according to claim 17, wherein the input data packet comprises a frame number of each logical frame and the peer operation data corresponding to the frame number, wherein:
the frame number is generated by the server through a global timer of the virtual scene; and in the virtual scene, frame numbers of a plurality of consecutive logical frames sequentially increase, and a time interval between two adjacent logical frames is the same.

20. The non-transitory computer-readable storage medium according to claim 17, wherein the updating the running logic in the current logical frame based on the input data packet, to obtain updated logic of the virtual scene in the current logical frame comprises:
obtaining a first frame number of a logical frame in the input data packet and a second frame number of the current logical frame;
determining a logical frame relationship between the logical frame in the input data packet and the current logical frame based on the first frame number and the second frame number; and
updating the running logic in the current logical frame based on the logical frame relationship, to obtain the updated logic of the virtual scene in the current logical frame.
